(19) United States
(12) Patent Application Publication
(10) Pub. No.: US 2013/0075384 A1
(43) Pub. Date: Mar. 28, 2013

(54) PERSONAL LUBRICANT WARMING APPARATUS

(71) Applicants: MICHELLE RUSSILLO, HUNTINGTON BEACH, CA (US); Tia Beth Greenberg, Huntington Beach, CA (US)

(72) Inventors: MICHELLE RUSSILLO, HUNTINGTON BEACH, CA (US); Tia Beth Greenberg, Huntington Beach, CA (US)

(21) Appl. No.: 13/543,653

(22) Filed: Jul. 6, 2012

Related U.S. Application Data
(60) Provisional application No. 61/540,193, filed on Sep. 28, 2011.

(51) Int. Cl. B67D 7/80; H05B 3/02

(52) U.S. Cl. 219/214; 219/507; 219/482

(57) ABSTRACT

A lubricant warming apparatus may warm a container of lubricant to a desired temperature. The apparatus may include an outer shell, a heating shell, and a receptacle. The heating shell maybe nested within the outer shell. The receptacle may be nested within the heating shell. The heating shell may include a lip with tapering contour sides that slope downward from a collar to a front end of the heating shell. The tapering contour sides may expose a front face of the receptacle. A basket may be suspended into the receptacle holding the container of lubricant in a water bath.

### CROSS-REFERENCE TO RELATED APPLICATION

This application claims benefit under 35 U.S.C. §119(e) of U.S. Provisional Application No. 61/540,193 filed Sep. 28, 2011, which is hereby incorporated by reference herein in its entirety.

### BACKGROUND OF THE INVENTION

The present invention generally relates to receptacles, and more particularly, to a personal lubricant warming apparatus.

Toiletries applied to the person may often be applied directly from the bottle to the hand. In the case of, for example, personal lubricants, the lubricant is often at ambient temperature or below having been stored in a cabinet or similar storage location. Thus, the lubricant may often be cooler than the skin temperature to which it is applied to. This may provide an unpleasant if not shocking sensation to the person.

Additionally, some warmers may be filled with a water bath to warm the lubricant bottle. When the warmer is done heating, the warmer may need a person to empty the bath by holding the warmer unit with both hands to dump the water out from the internal chamber of the unit. This can be potentially messy and dangerous when hot water from inside the warmer can slosh out. In some cases, a user must wait until the unit cools down because the walls of the unit may be too hot to touch.

As can be seen, there is a need for an apparatus that can safely warm lubricants in their container prior to use. It can also be seen that there is a need for a warming apparatus that can be safely handled after the lubricant container is removed from the apparatus.

### SUMMARY OF THE INVENTION

In one aspect of the present invention, a lubricant warming apparatus comprises an outer shell; a heating shell disposed nested within the outer shell, the heating shell including a lip with tapering contour sides that slope downward from a collar to a front end of the heating shell; a heating element connected to the heating shell; and a receptacle nested within the heating shell, wherein the tapering contour sides of the heating shell expose a front face of the receptacle.

In another aspect of the present invention, a lubricant warming apparatus comprises a heat resistant outer shell including an interior wall defining the outer shell as an open faced enclosure; a heat conductive heating shell nested within the outer shell; a heating element connected to the heating shell; a receptacle nested within the heating shell; and a basket extending into the receptacle.

These and other features, aspects and advantages of the present invention will become better understood with reference to the following drawings, description and claims.

### BRIEF DESCRIPTION OF THE DRAWINGS

FIG. 1 shows a perspective view of a lubricant warming apparatus according to an exemplary embodiment of the invention; and

FIG. 2 shows an exploded perspective view of the apparatus of FIG. 1 with an inner receptacle removed for sake of illustration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claim.

Broadly, an embodiment of the present invention generally provides an apparatus for warming personal lubricant products. In one aspect, the present invention may controllably warm lubricant stored in a bottle so that the lubricant can be applied warm to a person's skin. In another aspect, the present invention may provide a homogenous heating of the lubricant so that, when extracted from its container, the lubricant is evenly heated. Another feature of the apparatus includes an inner receptacle, conveniently accessible and separable from a heating element, which allows one to safely empty a water bath from the apparatus.

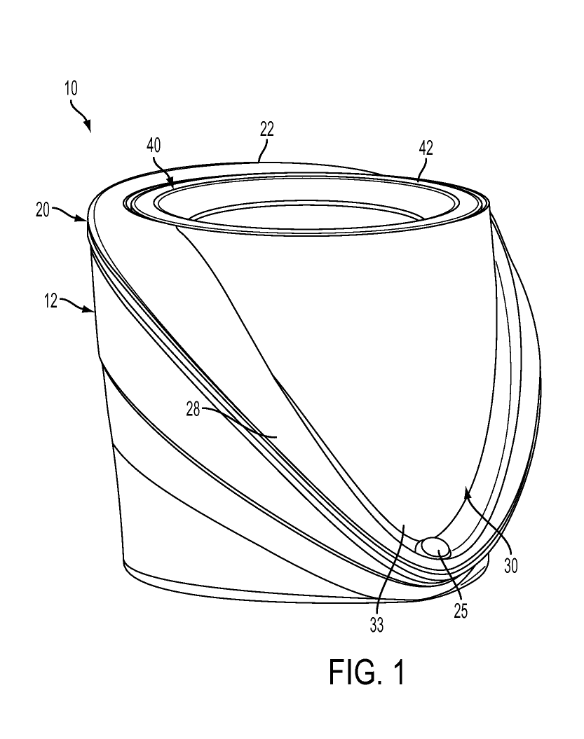

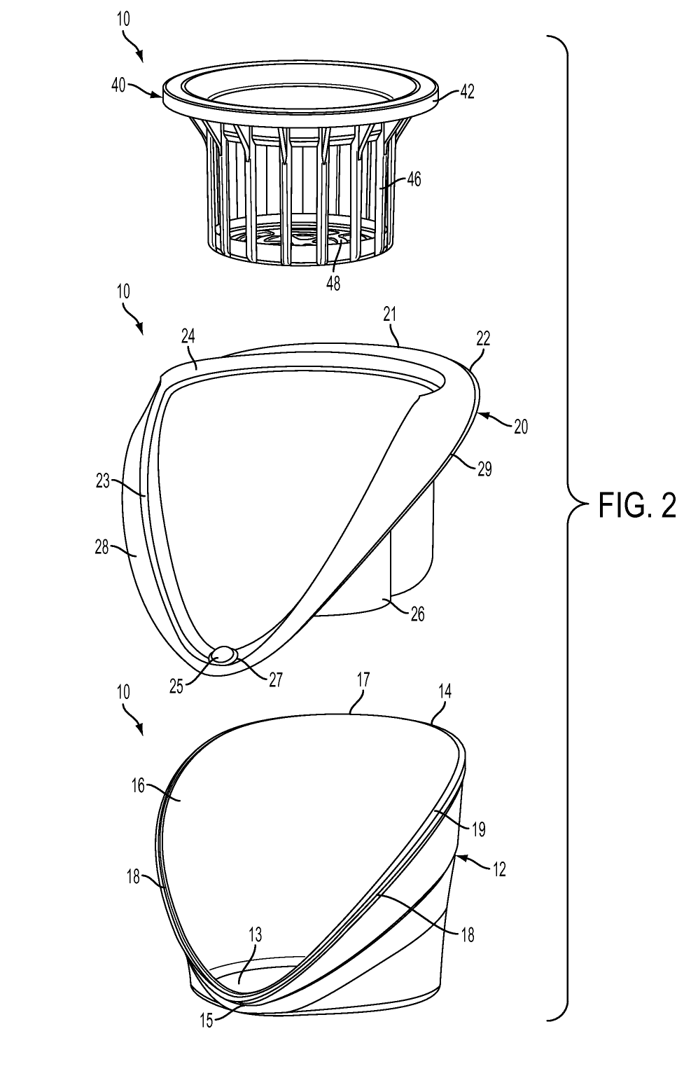

Referring now to FIGS. 1 and 2, a lubricant warming apparatus 10 is shown according to an exemplary embodiment of the present invention. The lubricant warming apparatus 10 may comprise an outer shell 12, a heating shell 20, an inner receptacle 30, and a basket 40. In an exemplary embodiment, the outer shell 12, heating shell 20, inner receptacle 30, and basket 40 may be nested.

The outer shell 12 may be configured to receive and house the heating shell 20. The outer shell 12 may include a rim 14. The rim 14 may include a rear, upper portion 17 that may be planar to a base 13. The rim 14 may also include tapering walls 18 that may slope downward from the rear, upper portion 17 to a front end 15 so that an interior wall 16 may be define the outer shell 12 as an open-faced enclosure. The rim 14 may also include a groove 19 around the rim's periphery configured to receive a tab 29 of the heating shell 20 when the heating shell 20 is nested onto the outer shell 12. The outer shell 12 may be heat resistant plastic that may insulate the heating shell 20. For example, the out shell 12 may prevent heat from leaving the heating shell 20 where the heating shell 20 is covered by the outer shell 12.

The heating shell 20 may be heat conductive. The heating shell 20 may include a lip 21 configured to rest atop the rim 14. The lip 21 may include a collar 22 positioned in the rear, upper portion of the lip 21. The lip 21 may also include tapering contour sides 28 that may slope downward from the collar 22 to a front end 27. The front end 27 may be a nadir at the convergence of side walls 28. The tab 29 may project downward from the lip 21 and may be positioned around the periphery of the lip 21. A heating element 26 may be connected to the heating shell 20. In an exemplary embodiment, the heating element 26 may be housed within a wall 23. For example, the heating element 26 may be a metallic disk positioned proximate the heating shell 20 bottom, incorporated within the wall 23. A switch 25 may be positioned near the front end 27. The switch 25 may be configured to enable or disable heating from the heating element 26. The switch 25 may be connected to a thermostat (not shown) operative to control heating of the heating element 26. In some embodiments, the switch 25 may be rotatable or otherwise adjustable to control the level of the thermostat. In an exemplary embodiment, the switch 25 may be a depressible button with an interior light source (not shown) that can change light color to indicate whether the heating element 26 is enabled or disabled. The wall 23 may be configured to receive the nested inner receptacle 30. A seat 24 may be positioned proximate to and below the collar 22. The seat 24 may be configured to receive a lip 42 of the basket 40 when the basket 40 is nested into the inner receptacle 30.

The inner receptacle 30 may be nested between the heating shell 20 and the basket 40. The inner receptacle 30 may be a cylindrical chamber configured to be received by the heating element 20. An outer wall 33 of the inner receptacle 30 may be in contact with the wall 23 of the heating shell 20 when the inner receptacle 30 is nested. The inner receptacle 30 may be heat conductive plastic. A front face portion of the outer wall 33 may be exposed as a result of being positioned between the tapering side walls 28 of the heating element 20. The inner receptacle 30 may house a water bath (not shown) and the basket 40.

The basket 40 may extend into the interior of the inner receptacle 30. The basket 40 may, in some exemplary embodiments, include an open configuration. For example, the basket 40 may include a plurality of supports 46 spaced apart from one another and joined together at a basket bottom floor 48. The length of the supports 46 may be provide a depth such that when suspended into the water bath, the basket bottom floor 48 may be out of direct contact with the heating shell 26. The basket bottom floor 48 may be perforated to allow water to enter the basket 40 interior.

In an exemplary use of the lubricant warming apparatus 10, the inner receptacle 30 may be filled with water. In embodiments where the inner receptacle 30 is separable from the heating shell 20, the inner receptacle 30 is placed within the interior of the heating shell 20. A lubricant container (not shown) may be placed in the basket 40 and lowered into the inner receptacle 30 interior. Water may pass through the supports 46 and bottom floor 48 to surround the lubricant container. The switch 25 may be enabled to turn on the heating element 26. The heating element 26 may heat the wall 23, which may heat the inner receptacle wall 33. The heat may be transferred into the inner receptacle interior heating the water bath and the lubricant container. However, it may be appreciated that the exposed front face portion may be cooler than the rest of the wall 33 while the interior of the inner receptacle 30 remains heated. When the lubricant container is sufficiently warmed, the lubricant container may be removed from the basket 40. The switch 25 may be operated to turn off the heating element 26. The basket 40 may be removed from the inner receptacle 30. A user may grasp the exposed front face portion with one hand, or optionally, may use the second hand to grasp the outer shell 12 to dump the water bath without risk of burn.

It should be understood, of course, that the foregoing relates to exemplary embodiments of the invention and that modifications may be made without departing from the spirit and scope of the invention as set forth in the following claim.

What is claimed is:

1. A lubricant warming apparatus, comprising:
an outer shell;
a heating shell disposed nested within the outer shell, the heating shell including a lip with tapering contour sides that slope downward from a collar to a front end of the heating shell;
a heating element connected to the heating shell; and
a receptacle nested within the heating shell, wherein the tapering contour sides of the heating shell expose a front face of the receptacle.

2. The lubricant warming apparatus of claim 1 wherein, the outer shell includes a rim including:
a rear, upper portion, the rear, upper portion being planar to a base of the outer shell, and
tapering walls that slope downward from the rear, upper portion to a front end of the outer shell.

3. The lubricant warming apparatus of claim 2, wherein the rim includes a groove configured to receive a tab on the heating shell.

4. The lubricant warming apparatus of claim 1, further comprising a basket nested within the receptacle.

5. The lubricant warming apparatus of claim 4, wherein the basket includes a depth such that when suspended into the water bath, a basket bottom floor is out of direct contact with the heating element.

6. The lubricant warming apparatus of claim 1 wherein, the outer shell is heat resistant.

7. The lubricant warming apparatus of claim 1, wherein the outer shell is operative to insulate the heating shell where the heating shell is covered by the outer shell.

8. The lubricant warming apparatus of claim 1, wherein the tapering contour sides form a nadir at the front end of the heating shell.

9. A lubricant warming apparatus, comprising:
a heat resistant outer shell including an interior wall defining the outer shell as an open faced enclosure;
a heat conductive heating shell nested within the outer shell;
a heating element connected to the heating shell;
a receptacle nested within the heating shell; and
a basket extending into the receptacle.

10. The lubricant warming apparatus of claim 9, wherein a front face of the heating shell is exposed through the outer shell.

11. The lubricant warming apparatus of claim 9, wherein the basket includes spaced supports.

12. The lubricant warming apparatus of claim 11, wherein the basket supports define a basket depth such that when suspended into the receptacle, a basket bottom floor is out of direct contact with the heating shell.

13. The lubricant warming apparatus of claim 11, wherein the basket includes a lip disposed to rest upon the heating shell.

14. The lubricant warming apparatus of claim 9, further comprising a switch connected to the heating element, the switch being operative to enable or disable the heating element.

15. The lubricant warming apparatus of claim 14, wherein the switch includes an indicator light.

16. The lubricant warming apparatus of claim 15, wherein the switch is configured to control the heating level of the heating element.
